(19) United States
(12) Patent Application Publication
(10) Pub. No.: US 2024/0202160 A1
(43) Pub. Date: Jun. 20, 2024

(54) PROCESSOR, COMPUTER-READABLE RECORDING MEDIUM STORING INSTRUCTION EXECUTION PROGRAM, AND INFORMATION PROCESSING DEVICE

(71) Applicant: Fujitsu Limited, Kawasaki-shi (JP)

(72) Inventor: Kentaro KAWAKAMI, Kawasaki (JP)

(73) Assignee: Fujitsu Limited, Kawasaki-shi (JP)

(21) Appl. No.: 18/240,411

(22) Filed: Aug. 31, 2023

(30) Foreign Application Priority Data
Dec. 19, 2022 (JP) 2022-202515

(51) Int. Cl. G06F 15/80

(52) U.S. Cl. CPC G06F 15/8015

(57) ABSTRACT

A processor executes a processing of a single instruction multiple data (SIMD) instruction. The processing includes: performing an operation between each lane of a first SIMD register that has a lane that stores first input data and a specific lane of a second SIMD register that has a lane that stores second input data; storing the operation result in a third SIMD register; and shifting data of each lane of the second SIMD register by one lane and storing the data in the second SIMD register.

### CROSS-REFERENCE TO RELATED APPLICATION

This application is based upon and claims the benefit of priority of the prior Japanese Patent Application No. 2022-202515, filed on Dec. 19, 2022, the entire contents of which are incorporated herein by reference.

### FIELD

The embodiment discussed herein is related to a processor, an instruction execution program, and an information processing device.

### BACKGROUND

A single instruction multiple data (SIMD) instruction for performing an operation on a plurality of pieces of data with a single instruction has been known. By using the single SIMD instruction, not the plurality of SIMD instructions, the same operation can be performed in parallel, on data in each of a plurality of SIMD lanes included in two SIMD registers. Here, in a case of a 64-bit mode central processing unit (CPU) of an Arm architecture, regarding a bit length of the single SIMD register, one length of 128×n (n: natural number) can be selected from among 128 bits to 2048 bits by a vendor for developing the CPU. For example, the SIMD register includes 512 bits and can store eight pieces of 64-bit data.

Japanese Laid-open Patent Publication No. 2018-206413, Japanese National Publication of International Patent Application No. 2018-525730, Japanese National Publication of International Patent Application No. 2018-523237, and Japanese National Publication of International Patent Application No. 2020-533691 are disclosed as related art.

### SUMMARY

According to an aspect of the embodiments, a processor executes a processing of a single instruction multiple data (SIMD) instruction. The processing includes: performing an operation between each lane of a first SIMD register that has a lane that stores first input data and a specific lane of a second SIMD register that has a lane that stores second input data; storing the operation result in a third SIMD register; and shifting data of each lane of the second SIMD register by one lane and storing the data in the second SIMD register.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of a source program including a polynomial calculation;

FIG. 2A is a reference diagram (1) illustrating an executable program in machine language obtained by compiling a source program;

FIG. 2B is a reference diagram (2) illustrating the executable program in the machine language obtained by compiling the source program;

FIG. 3 is a diagram illustrating a flow of processing of a multiplication instruction with SIMD lane shift according to an embodiment;

FIG. 4 is a diagram illustrating a flow of processing of an addition instruction with SIMD lane shift according to the embodiment;

FIG. 5 is a hardware configuration diagram of an information processing device according to the embodiment;

FIG. 6 is a schematic diagram of a register file included in a processor according to the embodiment;

FIG. 7 is a functional configuration diagram of the information processing device according to the embodiment;

FIG. 8A is a diagram (1) illustrating an example of an executable program in machine language obtained by compiling the source program;

FIG. 8B is a diagram (2) illustrating an example of the executable program in the machine language obtained by compiling the source program;

FIG. 9 is a diagram illustrating an example of a flowchart of operation command execution processing with lane shift according to the embodiment;

FIG. 10 is a diagram illustrating a modification of the multiplication instruction with SIMD lane shift according to the embodiment;

FIG. 11 is a reference diagram of a SIMD instruction (multiplication);

FIG. 12 is a reference diagram of a SIMD instruction (multiplication) with lane designation;

FIG. 13 is a reference diagram illustrating a bit configuration of the SIMD instruction (multiplication) with lane designation; and

FIG. 14 is a reference diagram illustrating an instruction to shift data in a SIMD register.

### DESCRIPTION OF EMBODIMENTS

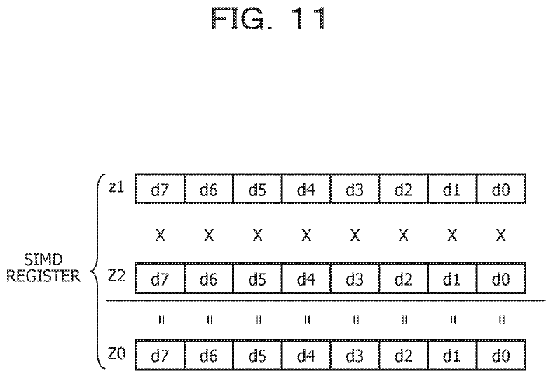

FIG. 11 is a reference diagram of a SIMD instruction (multiplication). Note that, in FIG. 11, a case is illustrated where a SIMD instruction of multiplication is “fmul z0.d,z1.d,z2.d”. As illustrated in FIG. 11, the SIMD instruction of the multiplication multiplies data of a SIMD register z1 and data of a SIMD register z2 (64-bit floating-point data) for each element and stores the result in a SIMD register z0. Here, “.d” represents that the SIMD register is treated as including a plurality of pieces of 64-bit data, and “.b”, “.h”, and “.s” respectively represent that the SIMD register is treated as including a plurality of pieces of 8-bit, 16-bit, and 32-bit data. For example, “fmul z0.s,z1.s,z2.s” multiplies the data of the SIMD register z1 and the data of the SIMD register z2 (32-bit floating-point data) for each element and stores the result in the SIMD register z0.

Lower 128 bits of the single SIMD register share data with another register. It is assumed that the another register be referred to as a v register here. In a case where the v register is used for multiplication, a SIMD instruction (multiplication) designating a lane can be used.

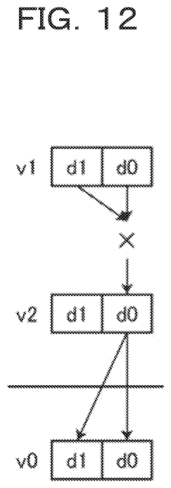

FIG. 12 is a reference diagram of a SIMD instruction (multiplication) with lane designation. Note that, in FIG. 12, a case is illustrated where a SIMD instruction of multiplication with lane designation is “fmul v0.d,v1.d,v2.d[0]”. As illustrated in FIG. 12, the SIMD instruction of the multiplication multiplies each element of a register v1 and data of a “0” lane of a register v2 (64-bit floating-point data) and stores each element in a register v0. In each SIMD lane of the v0, a value of (value of each lane of v1 register)×(d0 (lane #0) of v2 register) is stored. The SIMD instruction of the multiplication with lane designation may be “fmul v0.d,v1.d,v2.d[1]”,

However, in a case where the SIMD register is equal to or more than 256 bits, it is not possible to use the SIMD instruction of the multiplication with lane designation. For example, in a case where the SIMD register is 512 bits, it is not possible to use a SIMD instruction (multiplication) of “fmul z0.d,z1.d,z2.d[0 to 7]”. Furthermore, in a case where the SIMD register is 1024 bits, it is not possible to use a SIMD instruction (multiplication) of “fmul z0.d,z1.d,z2.d[0 to 31]”.

In a case where the SIMD register is equal to or more than 256 bits, the reasons why the SIMD instruction of the multiplication with lane designation does not exist are as follows. This is because, although an instruction of the 64-bit mode CPU of the Arm architecture includes 32 bits per instruction, only one bit for lane designation can be secured in the 32-bit configuration.

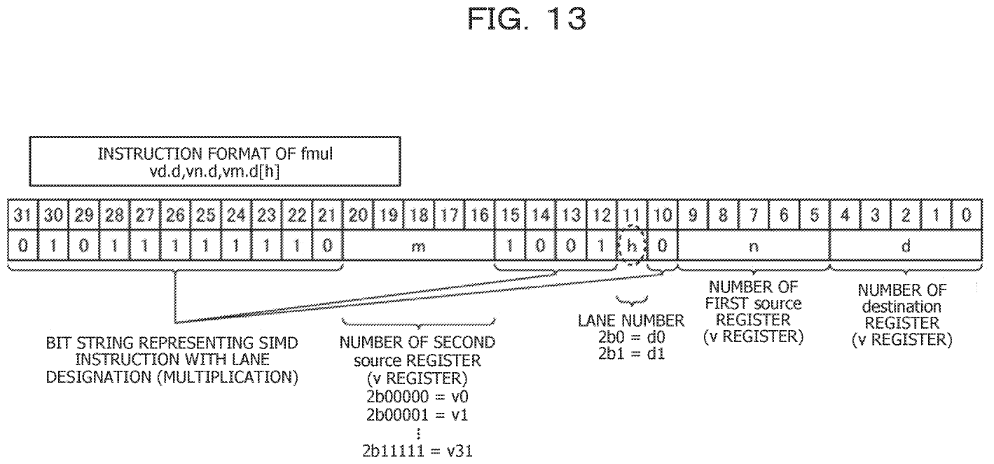

FIG. 13 is a reference diagram illustrating a bit configuration of a SIMD instruction (multiplication) with lane designation. Note that, in FIG. 13, a case is illustrated where the SIMD instruction of the multiplication with lane designation is “fmul vd.d,vn.d,vm.d[h]”. As illustrated in FIG. 13, fifth to ninth bits are a bit string representing a number of a first source register indicated by “vn”. Sixteenth to 20-th bits are a bit string representing a number of a second source register indicated by “vm”. Zero-th to fourth bits are a bit string representing a number of a destination register indicated by “vd”. Then, 10-th bit, 12-th to 15-th bits, and 21-st to 31-st bits are bit strings representing a SIMD instruction with lane designation. Then, an 11-th bit indicates a bit for designating a lane number. In a case where a value is “0” of a binary number, this indicates that the lane number is “0” (h=0), and in a case where the value is “1” of the binary number, this indicates that the lane number is “1” (h=1). For example, only one bit for designating the lane number is included in 32 bits of the SIMD instruction with lane designation.

For example, in a case where the SIMD register is 1024 bits, 32 pieces of 64-bit data is included. Therefore, it is necessary to be able to designate zero to 31 in a bit configuration of an instruction format including 32 bits. Although it is necessary to secure five bits in order to designate zero to 31, there is no empty bit used to secure five bits. Therefore, there is no room for defining the instruction format with lane designation based on the SIMD instruction using the SIMD register.

However, even if lane designation is abandoned in a case of a SIMD register with 256 bits or more, there is a case where it is desired to perform an operation of each element of a register z1 and data of a specific lane of a register z2 and to realize an efficient execution code (executable program).

According to one aspect, an object is to realize an efficient execution code.

Prior to the description of the present embodiment, the matters as the basics of the present embodiment will be described.

In a source program, a code for various operations may be described. If such operations can be efficiently executed, an execution speed of the operation described in the source program also increases. Therefore, for example, a source program including a polynomial calculation will be described below.

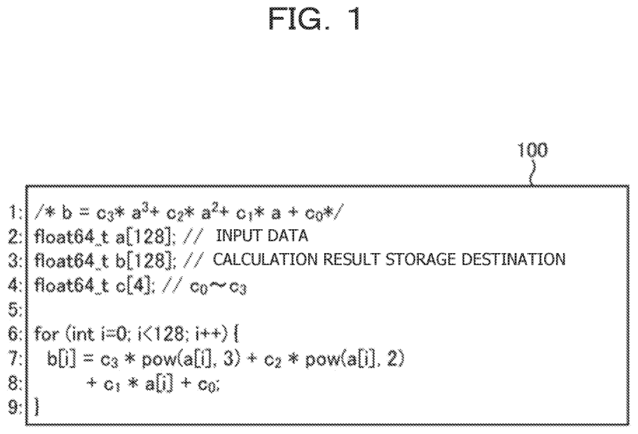

FIG. 1 is a diagram illustrating an example of the source program including the polynomial calculation. This source program 100 is a program that repeatedly performs a polynomial calculation described in a seventh line and an eighth line by only a loop length 128, in loop processing based on a for loop in sixth to ninth lines. The reference a[i] (i=0 to 127) is a sequence data. The references C0, C1, C2, C3 are coefficients. Note that a type of each piece of data is a 64-bit float (float64_t).

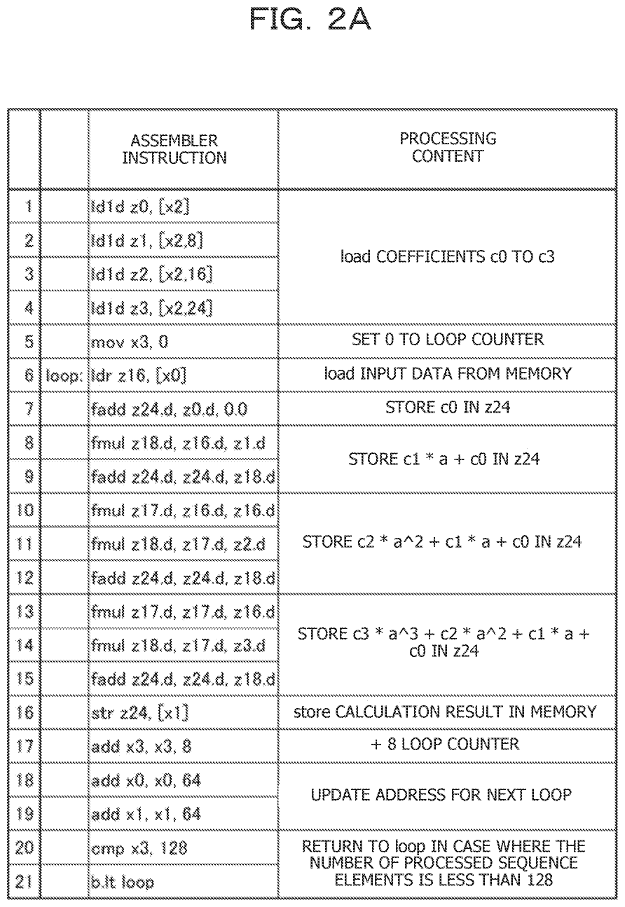

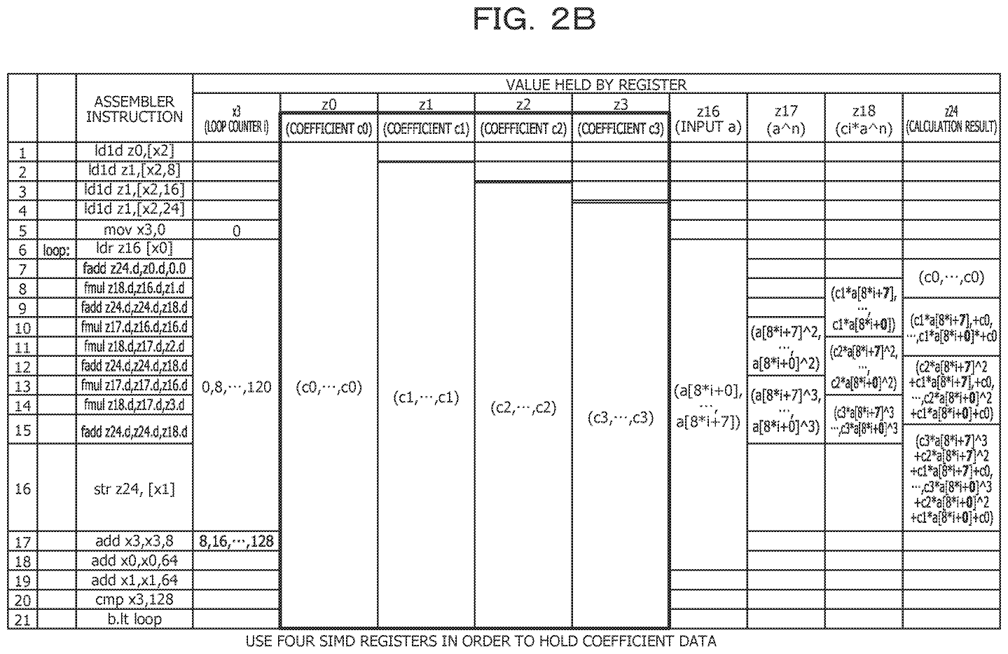

FIGS. 2A and 2B are reference diagrams illustrating an executable program in machine language obtained by compiling the source program. In FIG. 2A, assembler instruction sequences obtained by compiling the source program 100 illustrated in FIG. 1 and converting the source program 100 into assembler instructions are illustrated. The coefficients c0, C1, C2, and c3 indicated in the source program 100 are respectively represented as c0, c1, c2, and c3. Furthermore, in FIG. 2B, a plurality of registers used in the assembler instruction sequences is illustrated, and a value held by each register is illustrated in association with each assembler instruction.

First, in the first line, an information processing device executes a SIMD instruction to load the coefficient c0 into a SIMD register z0. In a case where a size of a SIMD register z is 512 bits, eight coefficients c0 each indicated by 64 bits are stored in the SIMD register z0 (refer to z0 in FIG. 2B). Similarly, in the second to fourth lines, the information processing device 1 executes a SIMD instruction to load the coefficients c1 to c3 respectively to SIMD registers z1 to z3 (refer to z1 to z3 in FIG. 2B).

Next, in the fifth line, the information processing device sets “0” as an initial value of a loop counter to a general-purpose register x3. Then, in the sixth line, the information processing device loads input data stored in a memory region where a general-purpose register x0 holds an address, into a SIMD register z16. For example, in a case where an instruction in the sixth line is executed first, eight (i=0 to 7) elements, from the head, in a sequence element of input data a illustrated in FIG. 1 are stored in the SIMD register z16 (refer to z16 in FIG. 2B).

Next, in the seventh line, the information processing device stores, in a SIMD register z24, a result of adding the coefficient c0 stored in the SIMD register z0 and 0.0.

Then, in the eighth and ninth lines, the information processing device stores a result of calculating “c1×a+c0” in the SIMD register z24 as follows. For example, the information processing device multiplies the SIMD register z16 that stores eight pieces of data of a sequence a and the SIMD register z1 that stores the eight coefficients c1 and stores the result in a SIMD register z18 (eighth line). For example, in a case where the size of the SIMD register z is 512 bits, the information processing device can calculate 64-bit data×eight pieces, by using a SIMD instruction “fmul” using the SIMD register z. Then, the information processing device adds the SIMD register z18 indicating the multiplication result and the SIMD register z24 that stores the eight coefficients c0 and stores the result in the SIMD register z24 (ninth line).

Then, in the tenth to twelfth lines, the information processing device stores a result of calculating “c2×a\hat{ }2+c1×a+c0” in the SIMD register z24 as follows. For example, the information processing device squares the SIMD register z16 that stores the eight pieces of data of the sequence a and stores the result in a SIMD register z17 (tenth line). For example, in a case where the size of the SIMD register z is 512 bits, the information processing device can calculate 64-bit data×eight pieces, by using a SIMD instruction “fmul” using the SIMD register z. Then, the information processing device multiplies the SIMD register z17 of the multiplication result and the SIMD register z2 that stores the eight coefficients c2 and stores the result in the SIMD register z18 (11-th line). Then, the information processing device 1 adds the SIMD register z18 indicating a multiplication result “c2×a\hat{ }2” and the SIMD register z24 that stores the result of “c1×a+c0” and stores the result in the SIMD register z24 (12-th line).

Then, in the 13-th to 15-th lines, the information processing device stores a result of calculating “c3×a\hat{ }3+c2×a\hat{ }2+c1×a+c0” in the SIMD register z24 as follows. For example, the information processing device multiplies the SIMD register z16 that stores the eight pieces of data of the sequence a and the SIMD register z17 that stores eight values of the square of the data of the sequence a and stores the result in the SIMD register z17 (13-th line). For example, in a case where the size of the SIMD register z is 512 bits, the information processing device can calculate 64-bit data×eight pieces, by using a SIMD instruction “fmul” using the SIMD register z. Then, the information processing device multiplies the SIMD register z17 of a multiplication result “a\hat{ }3” and the SIMD register z3 that stores the eight coefficients c3 and stores the result in the SIMD register z18 (14-th line). Then, the information processing device 1 adds the SIMD register z18 indicating a multiplication result “c3×a\hat{ }3” and the SIMD register z24 that stores a result of “c2×a\hat{ }2+c1×a+c0” and stores the result in the SIMD register z24 (15-th line).

Then, in the 16-th line, the information processing device stores a calculation result with respect to the eight pieces of input data a stored in the SIMD register z24, in a memory. Then, in the 17-th line, the information processing device adds the value of the loop counter held by the general-purpose register x3 by only eight. Then, in the 18-th and 19-th lines, the information processing device updates an address x0 of a memory region that loads input data and an address x1 of a memory region that stores a calculation result only by 64 bytes (=(64-bit data)×8/(8 (bit/byte)), for next loop processing. Then, in the 20-th and 21-th lines, in a case where the number of processed sequence elements (loop counter indicated by variable x3) is less than 128, the information processing device returns to the loop in the sixth line. In a by variable x3) is equal to or more than 128, the information processing device ends the processing.

In this way, for the executable program in the machine language obtained by compiling the source program 100, the information processing device uses the four SIMD registers (z0 to z3), in order to hold the data of the coefficients c0 to c3. For example, the SIMD instruction using a z register that is a SIMD register having a larger bit length than 128 bits does not have an instruction with lane designation, it is necessary to store the coefficients c0 to c3 respectively in the four SIMD registers (z0 to z3). For example, since the multiple coefficients are respectively stored in the different SIMD registers in the executable program corresponding to the source program 100 including the polynomial calculation, it is necessary to use a large number of SIMD registers. In the example in FIG. 2B, as the SIMD registers, z0, z1, z2, z3, z16, z17, z18, and z24 are used. In a case where these SIMD registers hold data to be used after the loop processing, it is necessary for the eight registers to temporarily save the saved data in the memory before starting the loop processing, and it is necessary to return the data of the eight registers from the memory after the loop processing has terminated. If a polynomial calculation can be performed with less number of SIMD registers, this is desirable because the number of instructions to be executed to evacuate and return the data to the memory is reduced.

Therefore, in the embodiment, calculation efficiency of the executable program in the machine language obtained by compiling the source program 100 including the polynomial calculation is improved by adding the SIMD instruction with lane shift. Note that, a case will be described below where a new SIMD instruction with lane shift is added to an instruction set of an Arm architecture (AArch64) of Arm company.

### EMBODIMENT

First, a SIMD instruction with lane shift will be described. In a case where two input SIMD registers are set as z1 and z2 and an output SIMD register is set as z0, the SIMD instruction with lane shift performs an operation using a value of each lane of the z1 and a value of a lane on a least significant bit (LSB) side of the z2, stores the operation result in each lane of the z0, and shifts the value of each lane of the z2 by one lane and stores the value in the z2. For example, the SIMD instruction with lane shift gives up to designate a lane number of the z2, performs an operation using each element of the z1 and the data of the lane on the LSB side of the z2, and cyclically shifts the data of the z2 by only one lane after the operation. The operation here includes addition, subtraction, multiplication, division, a remainder operation, a product-sum operation, and a logical operation. Furthermore, the cyclically shifting direction may be right shift or left shift. In a case where the shift is the right shift, the value of the lane on the LSB side is stored in a lane on a most significant bit (MSB) side after the shift. Note that, in the following description, it is assumed that the shift be the right shift.

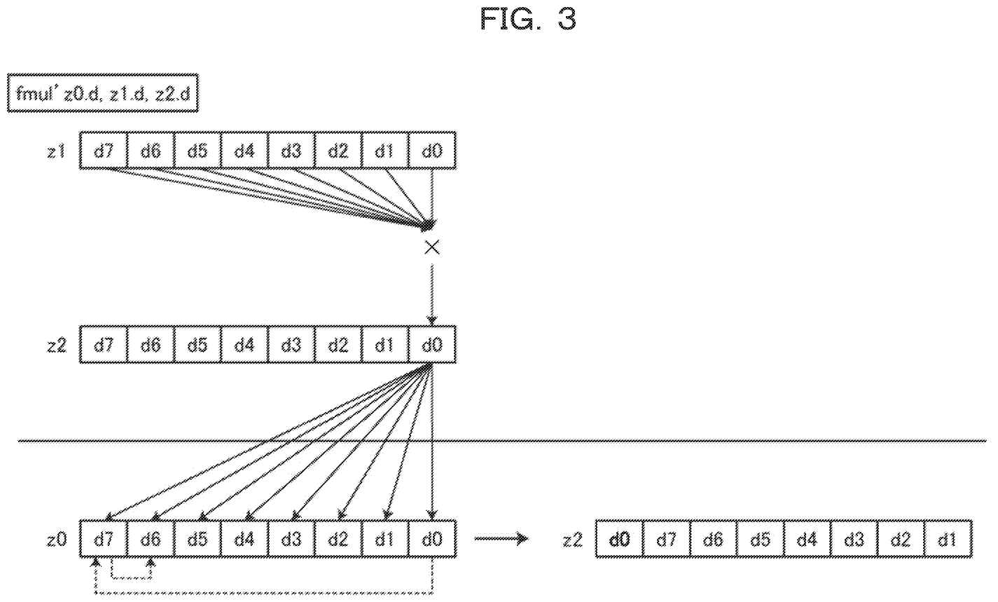

FIG. 3 is a diagram illustrating a flow of processing of a multiplication instruction with SIMD lane shift according to the embodiment. The multiplication instruction with SIMD lane shift illustrated in FIG. 3 is defined as, for example, “fmul′ z0.d,z1.d,z2.d”. The SIMD register z1 stores a multiplicand in each lane. The SIMD register z2 stores a multiplier in each lane. The SIMD register z0 is a destination register.

A multiplication instruction fmul′ with SIMD lane shift multiplies [value of each lane of SIMD register z1]×[d0 (lane #0) of SIMD register z2] and stores the multiplication result in each lane of the SIMD register z0. In addition, fmul′ shifts data of the SIMD register z2 to the right by only one lane, after the multiplication. For example, a value of a #(i+1)-th lane is stored in a #i-th (i=0 to 6) lane of the SIMD register z2. A value of a zero-th (LSB side) lane is stored in a seventh (MSB side) lane. Note that the value of each lane of the SIMD register z1 is not changed.

As a result, the source program 100 including the polynomial calculation can realize an efficient execution code. For example, in the source program 100 for calculating a polynomial such as “b[i]=c3×a[i]\hat{ }3+c2×a[i]\hat{ }2+c1×a[i]+c0” with respect to sequences a[i] and b[i] illustrated in FIG. 1, the execution codes illustrated in FIGS. 2A and 2B have needed to prepare the four SIMD registers having the same coefficients c3 to c0 for all the lanes. However, if the multiplication instruction with SIMD lane shift is newly added, a calculation can be realized with a single SIMD register having the coefficients c3 to c0 in each lane, and it is possible to reduce the number of required SIMD registers. As a result, the source program 100 including the polynomial calculation can realize an efficient execution code.

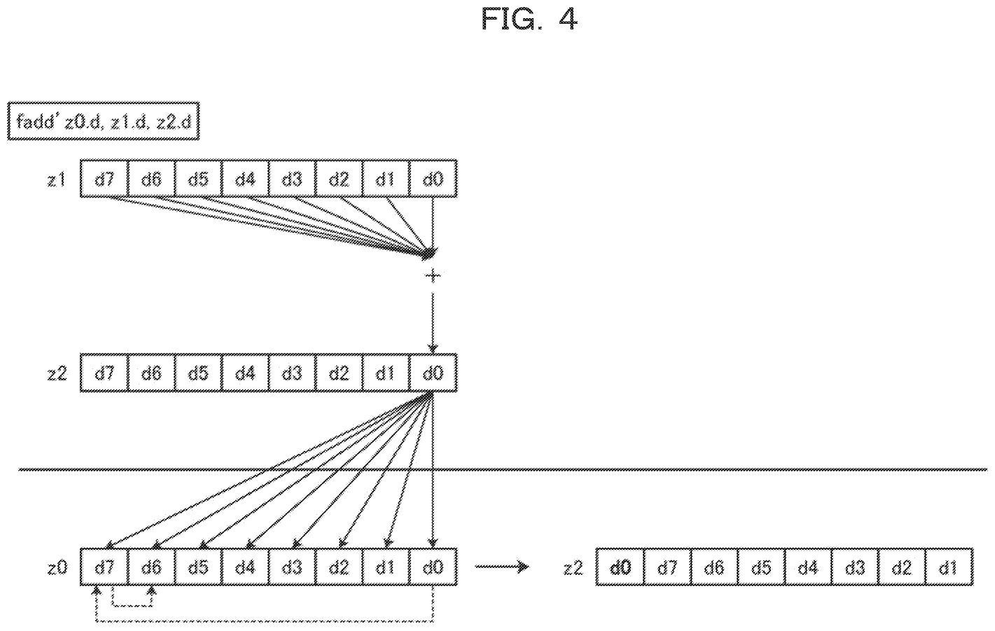

FIG. 4 is a diagram illustrating a flow of processing of an addition instruction with SIMD lane shift according to the embodiment. The addition instruction with SIMD lane shift illustrated in FIG. 4 is defined as, for example, “fadd′ z0.d,z1.d,z2.d”. The SIMD register z1 stores a summand in each lane. The SIMD register z2 stores an addend in each lane. The SIMD register z0 is a destination register.

An addition instruction fadd′ with SIMD lane shift adds [value of each lane of SIMD register z1]+[d0 (lane #0) of SIMD register z2] and stores the addition result in each lane of the SIMD register z0. In addition, fadd′ shifts the data of the SIMD register z2 to the right by only one lane, after the addition. For example, a value of a #(i+1)-th lane is stored in a #i-th (i=0 to 6) lane of the SIMD register z2. A value of a zero-th (LSB side) lane is stored in a seventh (MSB side) lane. Note that the value of each lane of the SIMD register z1 is not changed.

Note that, in the above, the multiplication instruction and the addition instruction have been described. However, the other four basic arithmetic operations, the product-sum operation, and the logical operation are similarly processed.

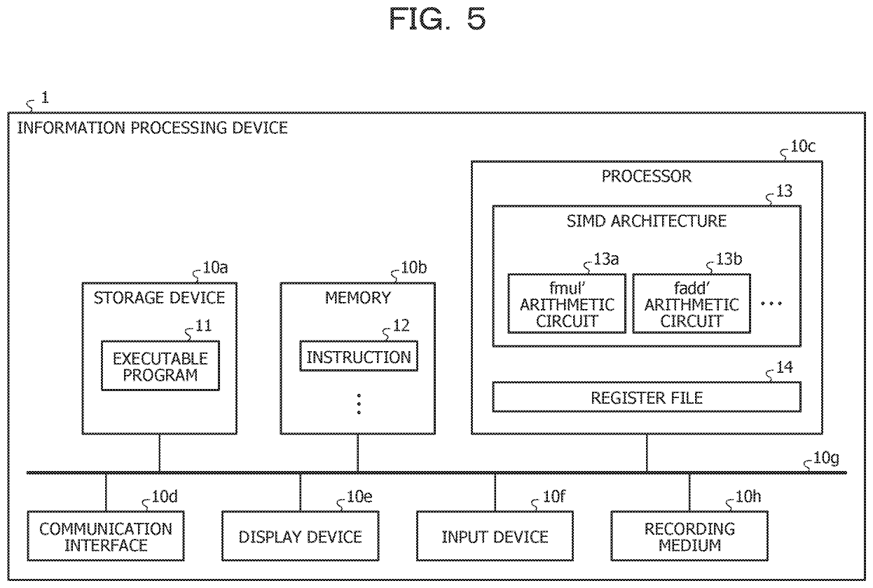

FIG. 5 is a hardware configuration diagram of the information processing device according to the embodiment. As illustrated in FIG. 5, the information processing device 1 is a computer such as a high performance computer (HPC) or a server, and includes a storage device 10a, a memory 10b, a processor 10c, a communication interface 10d, a display device 10e, and an input device 10f. These individual units are coupled to each other with a bus 10g.

Among these, the storage device 10a is a non-volatile storage device such as a hard disk drive (HDD) or a solid state device (SSD) and stores an executable program 11. The executable program 11 is a binary file in machine language obtained by compiling the source program 100 including the polynomial calculation illustrated in FIG. 1.

Note that the executable program 11 may be recorded in a computer-readable recording medium 10h, and the processor 10c may be caused to read the executable program 11 in the recording medium 10h.

As the recording medium 10h described above, for example, physically portable recording media such as a compact disc-read only memory (CD-ROM), a digital versatile disc (DVD), and a universal serial bus (USB) memory are included. In addition, a semiconductor memory such as a flash memory or a hard disk drive may be used as the recording medium 10h. The recording medium 10h mentioned above is not a temporary medium such as a carrier wave having no physical form.

Moreover, the executable program 11 may be stored in a device coupled to a public line, the Internet, a local area network (LAN), or the like, and the processor 10c may read and execute the executable program 11.

Meanwhile, the memory 10b is hardware that temporarily stores data as a dynamic random access memory (DRAM) or the like, and the executable program 11 described above is loaded in the memory 10b. The executable program 11 to be loaded includes a plurality of instructions 12. The instruction 12 includes the multiplication instruction fmul′ with SIMD lane shift, the addition instruction fadd′ with SIMD lane shift, or the like.

The processor 10c is hardware such as a central processing unit (CPU) or a graphical processing unit (GPU) that, for example, controls each unit of the information processing device 1 and executes the executable program 11 in cooperation with the memory 10b. The processor 10c includes a SIMD architecture 13 and a register file 14. The register file 14 holds data necessary for calculation operations.

The SIMD architecture 13 includes, for example, an arithmetic circuit corresponding to the instruction set of the Arm architecture (AArch64). Furthermore, the SIMD architecture 13 includes, for example, a fmul′ arithmetic circuit 13a that processes a multiplication instruction with lane shift and a fadd′ arithmetic circuit 13b that processes an addition instruction with lane shift. A shift circuit that performs a shift by one lane is mounted on each of the fmul′ arithmetic circuit 13a and the fadd′ arithmetic circuit 13b. The shift circuit that performs the shift by one lane shifts fixed 64 bits (8 bytes) and does not require a selector. Therefore, a processing time can be shortened.

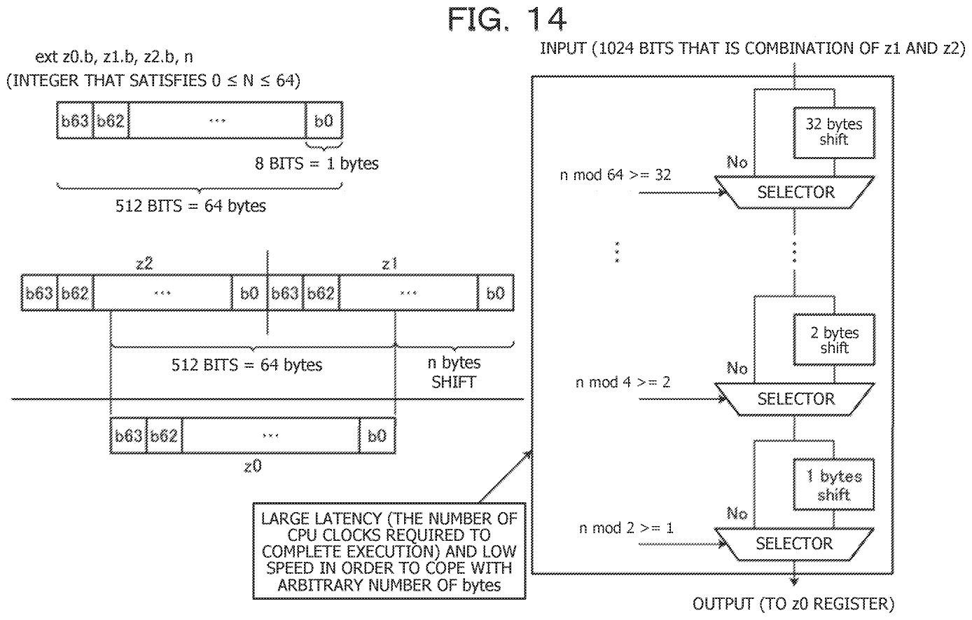

Note that the instruction set includes a shift instruction “ext” corresponding to an arbitrary number of bytes. FIG. 14 is a reference diagram illustrating an instruction to shift data in a SIMD register. As illustrated in the left diagram in FIG. 14, “ext z0.b,z1.b,z2.b,n” indicating a shift instruction is illustrated. In the example in FIG. 14, the ext instruction stores 512 bits obtained by shifting 1024-bit data that is a combination of the SIMD register z2 and the SIMD register z1 to the right by n bytes, in the SIMD register z0. For example, the ext instruction performs right shift by n bytes. The reference n indicates an integer that satisfies a condition such that a value is equal to or more than zero and equal to or less than 64. In the right diagram in FIG. 14, a shift circuit that executes the ext instruction corresponding to the arbitrary number of bytes is illustrated. In the shift circuit, a plurality of selectors is mounted so as to shift in accordance with n. Then, the shift circuit that executes the ext instruction corresponding to the arbitrary number of bytes needs to be implemented with a circuit having a large latency (the number of CPU clocks required to complete execution) and taking a longer processing time, in order to cope with the arbitrary number of bytes. On the other hand, the shift circuit mounted on the fmul′ arithmetic circuit 13a or the fadd′ arithmetic circuit 13b shifts 64 bits (8 bytes) for one fixed lane and has a simpler circuit, and can be realized with a circuit having a smaller latency and a shorter processing time.

Returning to FIG. 5, in addition, the communication interface 10d is an interface for coupling the information processing device 1 to a network such as a local area network (LAN).

Then, the display device 10e is hardware such as a liquid crystal display device and displays prompts that prompt a developer to input various types of information. In addition, the input device 10f is hardware such as a keyboard and a mouse.

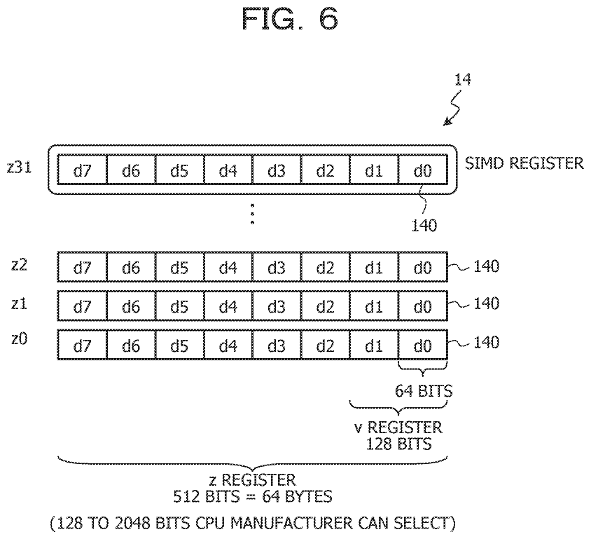

FIG. 6 is a schematic diagram of the register file 14 included in the processor 10c. A case where the processor 10c executes the instruction set of the AArch64 will be described below as an example.

As illustrated in FIG. 6, the register file 14 includes a plurality of SIMD registers 140. Note that, although not illustrated, the register file 14 includes a plurality of predicate registers and a plurality of scalar registers.

In a case of a CPU based on the Arm architecture (AArch64), a bit length of the SIMD register 140 may be implemented by selecting one of 128, 256, 384, 512, . . . , and 2048 by a vendor for developing the CPU. In FIG. 6, the bit length of the SIMD register is 512 bits. Then, the single SIMD register 140 can store eight pieces of 64-bit data. In the following, the multiple SIMD registers 140 are identified from each other by the character strings “z0”, “z1”, . . . , and “z31”.

Note that the lower 128 bits in the single SIMD register 140 share data with another register. It is assumed that the another register be referred to as a v register. In a case where the v register is used for an operation, a SIMD instruction designating a lane can be used.

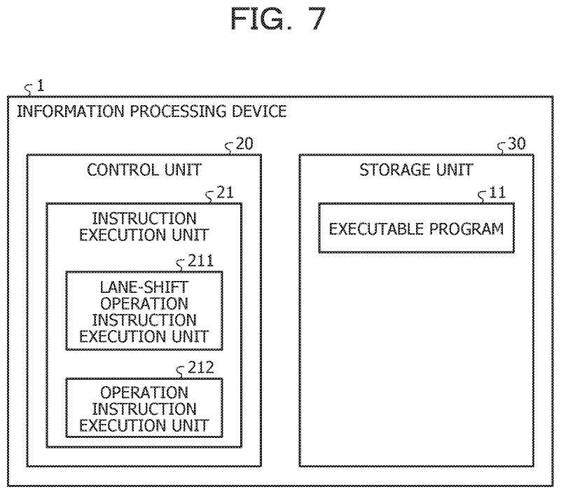

FIG. 7 is a functional configuration diagram of the information processing device 1 according to the embodiment. As illustrated in FIG. 7, the information processing device 1 includes a storage unit 30 and a control unit 20.

Among these, the storage unit 30 stores the executable program 11. As an example, the storage unit 30 is implemented by the storage device 10a and the memory 10b in FIG. 5. Note that the executable program 11 is a binary file in machine language obtained by compiling the source program 100 including the polynomial calculation illustrated in FIG. 1.

The control unit 20 is a processing unit that controls each unit of the information processing device 1. The functions of the control unit 20 are implemented by executing the executable program 11 by the memory 10b and the processor 10c in cooperation. The control unit 20 includes an instruction execution unit 21. The instruction execution unit 21 is a processing unit that executes each instruction at the time of executing the executable program 11. The instruction execution unit 21 includes a lane-shift operation instruction execution unit 211 and an operation instruction execution unit 212. Note that the instruction execution unit 21 executes each instruction included in the instruction set of the AArch64, other than operation instructions.

The lane-shift operation instruction execution unit 211 executes an operation instruction with lane shift of the SIMD register 140. For example, the lane-shift operation instruction execution unit 211 performs an operation using data in each lane of a first SIMD register 140 having a lane that stores first input data and a lane on an LSB side of a second SIMD register 140 having a lane that stores second input data. Then, the lane-shift operation instruction execution unit 211 stores the operation result in a third SIMD register 140. Then, the lane-shift operation instruction execution unit 211 shifts the data in each lane of the second SIMD register 140 to the right by one lane and stores the data in the second SIMD register 140. The operation instruction with lane shift here includes the multiplication instruction fmul′ with SIMD lane shift and the addition instruction fadd′ with SIMD lane shift.

The operation instruction execution unit 212 executes an operation instruction other than the operation instruction with lane shift. It is sufficient that the operation instruction other than the operation instruction with lane shift be an operation instruction included in the instruction set of the AArch64 including fmul and fadd.

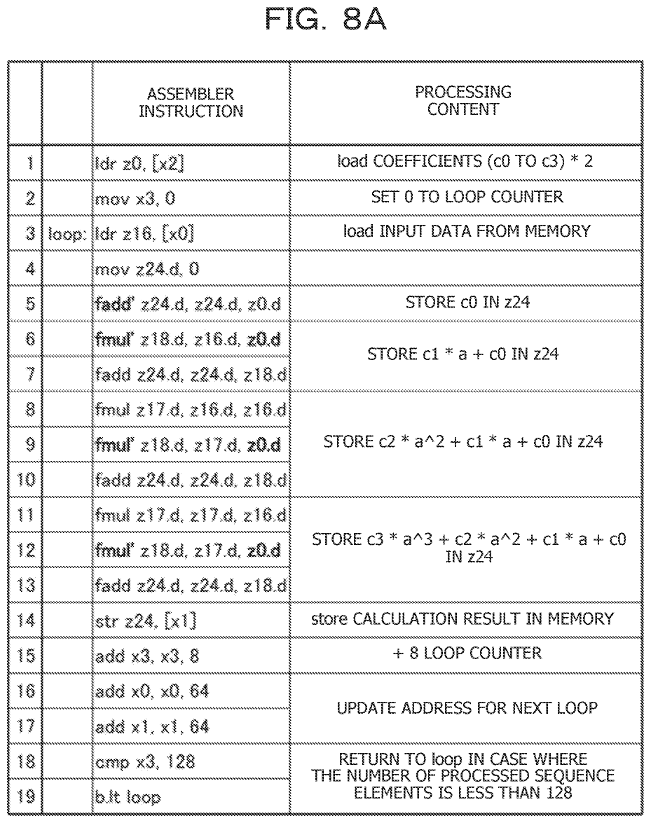

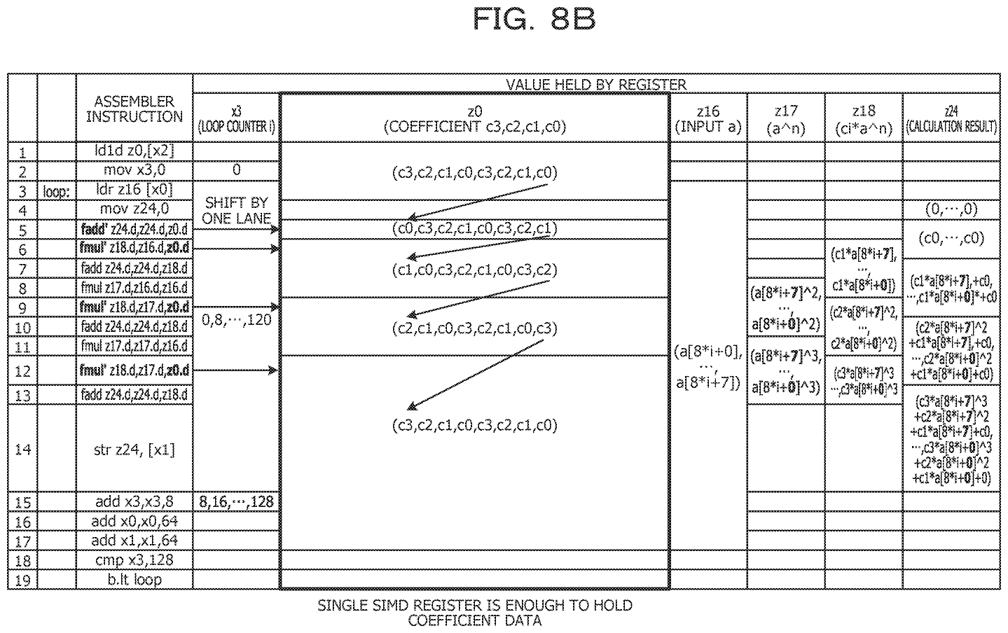

Here, an example of an executable program using the operation instruction with SIMD lane shift according to the embodiment will be described with reference to FIGS. 8A and 8B. FIGS. 8A and 8B are diagrams illustrating an example of an executable program in machine language obtained by compiling a source program. In FIG. 8A, assembler instruction sequences obtained by compiling the source program 100 illustrated in FIG. 1 and converting the source program 100 into assembler instructions are illustrated. The coefficients C0, C1, C2, and c3 indicated in the source program 100 are respectively represented as c0, c1, c2, and c3. Furthermore, in FIG. 8B, a plurality of registers used in the assembler instruction sequences is illustrated, and a value held by each register is illustrated in association with each assembler instruction.

First, in the first line, the information processing device 1 executes a SIMD instruction to load the coefficients c0 to c3 into the SIMD register z0. In a case where the size of the SIMD register z is 512 bits, two sets of the coefficients c0 to c3 indicated by 64 bits are stored in the SIMD register z0 in this order. For example, (c3, c2, c1, c0, c3, c2, c1, c0) is stored in the SIMD register z0 (refer to z0 in FIG. 8B). Note that it is assumed that coefficient data be stored in a memory region where a general-purpose register x2 holds an address, in this order in advance.

Next, in the second line, the information processing device 1 sets “0” as an initial value to the loop counter held by the general-purpose register x3. Then, in the third line, the information processing device 1 loads input data stored in the memory region where the general-purpose register x0 holds an address, into the SIMD register z16. For example, in a case where the loop counter indicated by the variable x3 is “0”, eight (i=0 to 7) elements, from the head, of the sequence element of the input data a illustrated in FIG. 1 are stored in the SIMD register z16.

Then, in the fourth line, the information processing device 1 stores the initial value “0” in the SIMD register z24.

Next, in the fifth line, the information processing device 1 stores the coefficient c0 stored in the SIMD register z0 into the SIMD register z24, using fadd′. For example, the information processing device 1 adds [value of each lane of SIMD register z24]+[d0 (lane #0) of SIMD register z0] and stores the addition result in each lane of the SIMD register z24. The SIMD register z24 stores (c0, c0, c0, c0, c0, c0, c0, c0) (refer to z24 in FIG. 8B). In addition, the information processing device 1 shifts the data of the SIMD register z0 to the right by only one lane, after the multiplication. As a result, the SIMD register z0 stores (c0, c3, c2, c1, c0, c3, c2, c1) (refer to z0 in FIG. 8B). For example, the information processing device 1 can store the coefficient “c0” used for the polynomial calculation in the SIMD register z24 using the SIMD instruction “fadd′” and can store the coefficient “c1” in the lane on the LSB side of the SIMD register z0.

Next, in the sixth line, the information processing device 1 stores a result of calculating “c1×a” in the SIMD register z24, using fmul′. For example, the information processing device 1 multiplies [value of each lane of SIMD register z16] that stores the eight pieces of data of the sequence a×[d0 (lane #0) of SIMD register z0] that stores [coefficient c1] and stores the multiplication result in each lane of the SIMD register z18. The SIMD register z18 stores (c1×a[8×i+7], . . . , c1×a[8×i+0]) (i=0) (refer to z18 in FIG. 8B). In addition, the information processing device 1 shifts the data of the SIMD register z0 to the right by only one lane, after the multiplication. As a result, the SIMD register z0 stores (c1, c0, c3, c2, c1, c0, c3, c2) (refer to z0 in FIG. 8B). For example, the information processing device 1 can calculate a polynomial calculation “c1×a” using the SIMD instruction “fmul”′ and store the coefficient “c2” to be used next after the polynomial calculation in the lane on the LSB side of the SIMD register z0.

Then, in the seventh line, the information processing device 1 stores a result of calculating “c1×a+c0” in the SIMD register z24 using fadd. For example, the information processing device 1 adds [value of each lane of SIMD register z24]+[value of each lane of SIMD register z18] and stores the addition result in each lane of the SIMD register z24.

Next, in the eighth and ninth lines, the information processing device 1 stores a result of calculating “c2×a\hat{ }2” in the SIMD register z18, using fmul and fmul′. For example, the information processing device 1 squares [value of each lane of SIMD register z16] that stores the eight pieces of data of the sequence a and stores the multiplication result in each lane of the SIMD register z17 (eighth line). Then, the information processing device 1 multiplies [value of each lane of SIMD register z17]×[d0 (lane #0) of SIMD register z0] that stores [coefficient c2] and stores the multiplication result in each lane of the SIMD register z18. The SIMD register z18 stores (c2×a[8×i+7]\hat{ }2, . . . , c2×a[8×i+0]\hat{ }2)(i=0) (refer to z18 in FIG. 8B). In addition, the information processing device 1 shifts the data of the SIMD register z0 to the right by only one lane, after the multiplication (ninth line). As a result, the SIMD register z0 stores (c2, c1, c0, c3, c2, c1, c0, c3) (refer to z0 in FIG. 8B). For example, the information processing device 1 can calculate a polynomial calculation “c2×a\hat{ }2” using the SIMD instruction “fmul” and store the coefficient “c3” to be used next after the polynomial calculation in the lane on the LSB side of the SIMD register z0.

Then, in the tenth line, the information processing device 1 stores a result of calculating “c2×a\hat{ }2+c1×a+c0” in the SIMD register z24, using fadd. For example, the information processing device 1 adds [value of each lane of SIMD register z24]+[value of each lane of SIMD register z18] and stores the addition result in each lane of the SIMD register z24.

Next, in the 11-th and 12-th lines, the information processing device 1 stores a result of calculating “c3×a\hat{ }3” in the SIMD register z18, using fmul and fmul′. For example, the information processing device 1 multiplies [value of each lane of SIMD register z17] that stores the eight squares of the data of the sequence a by [value of each lane of SIMD register z16] that stores the eight pieces of data of the sequence a and stores the multiplication result in each lane of the SIMD register z17 (11-th line). Then, the information processing device 1 multiplies [value of each lane of SIMD register z17]×[d0 (lane #0) of SIMD register z0] that stores the coefficient c3 and stores the multiplication result in each lane of the SIMD register z18. The SIMD register z18 stores (c3×a[8×i+7]\hat{ }3, . . . , c3×a[8×i+0]\hat{ }3)(i=0) (refer to z18 in FIG. 8B). In addition, the information processing device 1 shifts the data of the SIMD register z0 to the right by only one lane, after the multiplication (12-th line). As a result, the SIMD register z0 stores (c3, c2, c1, c0, c3, c2, c1, c0) (refer to z0 in FIG. 8B). For example, the information processing device 1 can calculate a polynomial calculation “c3×a\hat{ }3” using the SIMD instruction “fmul′” and store the coefficient “c0” to be used after the loop of the polynomial calculation in the lane on the LSB side of the SIMD register z0.

Then, in the 13-th line, the information processing device 1 stores a result of calculating “c3×a\hat{ }3+c2×a\hat{ }2+c1×a+c0” in the SIMD register z24, using fadd. For example, the information processing device 1 adds [value of each lane of SIMD register z24]+[value of each lane of SIMD register z18] and stores the addition result in each lane of the SIMD register z24.

Then, in the 14-th line, the information processing device 1 stores a calculation result with respect to eight pieces of input data a stored in the SIMD register z24, in the memory. Then, in the 15-th line, the information processing device 1 adds the value of the loop counter held by the general-purpose register x3 by only eight. Then, in the 16-th and 17-th lines, the information processing device 1 updates the address x0 of the memory region that loads the input data and the address x1 of the memory region that stores the calculation result only by 64 bytes, for next loop processing. Then, in the 18-th and 19-th lines, in a by variable x3) is less than 128, the information processing device 1 returns to the loop. In a case where the number of processed sequence elements (loop counter held by general-purpose register x3) is equal to or more than 128, the information processing device 1 ends the processing.

In this way, the information processing device 1 uses only one SIMD register 140 (z0) in order to hold the data of the coefficients c0 to c3 and performs the polynomial calculation on the sequence using the SIMD instruction with lane shift. As a result, the information processing device 1 can reduce the number of SIMD registers 140 used to store the coefficients than that in a case where the SIMD instruction with lane shift is not used, and an efficient execution code can be realized. In the example in FIG. 8B, z0, z16, z17, z18, and z24 are used as the SIMD registers. In a case where these SIMD registers hold data to be used after the loop processing, it is necessary for the five registers to temporarily save the saved data in the memory before starting the loop processing and to return the data of the five registers from the memory after the loop processing has terminated. This is desirable because the number of SIMD registers that need evacuation and return of the data is reduced and the number of instructions to be executed for the evacuation and the return of the data to the memory is reduced, as compared with FIG. 2B.

Furthermore, if the number of SIMD registers 140 used in the loop decreases, a polynomial calculation with a higher degree can be realized in one loop. Furthermore, if the number of SIMD registers 140 used in the loop decreases, there is an increasing room (optimization of execution code by compiler such as loop unrolling or software pipelining) for rearrangement to an instruction sequence that can be processed at a higher speed.

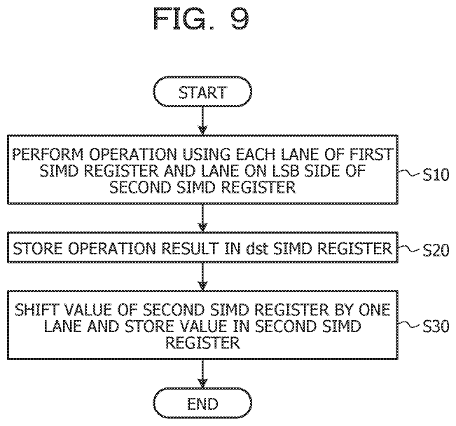

Next, the flowchart of the operation command execution processing with lane shift according to the embodiment will be described with reference to FIG. 9. FIG. 9 is a diagram illustrating an example of the flowchart of the operation command execution processing with lane shift according to the embodiment. Note that it is assumed that the SIMD register be 512 bits. Then, in each lane of the first SIMD register, for example, eight pieces of data is stored. In each lane of the second SIMD register, for example, values of a plurality of coefficients used for a polynomial calculation are stored.

As illustrated in FIG. 9, the lane-shift operation instruction execution unit 211 performs an operation between each lane of the first SIMD register and the lane on the LSB side of the second SIMD register (step S10). Then, the lane-shift operation instruction execution unit 211 stores the operation result in a dst (destination) SIMD register (step S20).

Then, the lane-shift operation instruction execution unit 211 shifts the value of the second SIMD register by one lane and stores the value in the second SIMD register (step S30).

For example, in a case where the operation instruction is the addition instruction with lane shift, the lane-shift operation instruction execution unit 211 can execute an operation instruction with lane shift “fadd′ z24.d,z24.d,z0.d” in the fifth line in FIG. 8A. Here, the z24 is a SIMD register of a first source operand, the z0 is a SIMD register of a second source operand, and in addition, the z24 is also a destination SIMD register. Eight “zeros (0)” indicating the initial value are stored in the z24. In the z0, (c3, c2, c1, c0, c3, c2, c1, c0) is stored as the coefficient used for the polynomial calculation. The instruction fadd′ adds each lane of the z24 and the lane (c0) on the LSB side of the z0 and stores the addition result in the z24 (steps S10 and S20). Then, fadd′ shifts the value of the z0 by one lane and stores the value in the z0 (step S30). In the z0, (c2, c3, c2, c1, c0, c3, c2, c1) is stored.

Furthermore, in a case where the operation instruction is the multiplication instruction with lane shift, the lane-shift operation instruction execution unit 211 can execute an operation instruction with lane shift “fmul′ z18.d,z16.d,z0.d” for executing “c1×a” indicated in the sixth line in FIG. 8A. Here, the z16 is the SIMD register of the first source operand, the z0 is the SIMD register of the second source operand, and the z18 is the SIMD register of a destination operand. In the z16, eight consecutive pieces of data of the sequence a is stored. In the z0, (c0, c3, c2, c1, c0, c3, c2, c1) is stored as the coefficient used for the polynomial calculation. The instruction fmul′ multiplies each lane of the z16 and the lane (c1) on the LSB side of the z0 and stores the multiplication result of “c1×a” in the z18 (steps S10 and S20). Then, fmul′ shifts the value of the z0 by one lane and stores the value in the z0 (step S30). In the z0, (c1, c0, c3, c2, c1, c0, c3, c2) is stored.

As a result, the lane-shift operation instruction execution unit 211 can further perform polynomial calculation using a value of a new lane on the LSB side of the z0.

Note that, in the embodiment, a case has been described where the operation with lane shift is multiplication and addition. However, the embodiment is not limited to this. The operation with lane shift may be various four basic arithmetic operations and logical operations such as subtraction, a remainder operation, a sum of products, a logical OR, a logical product, or an exclusive logical OR. Furthermore, the data stored in the SIMD register may be treated as floating-point data or integer data. In a case where the operation with lane shift is subtraction, it is sufficient to define a subtraction instruction with SIMD lane shift, for example, as “fsub′ z0.d,z1.d,z2.d”. Furthermore, in a case where the operation with lane shift is the sum of products, it is sufficient to define a sum of products instruction with SIMD lane shift, for example, as “fmad′ z0.d,z1.d,z2.d”. The sum of products calculates “z0.d=z1.d×z2.d+z1.d”. Furthermore, in a case where the operation with lane shift is the logical OR, it is sufficient to define a logical OR instruction with SIMD lane shift, for example, as “orr′ z0.d,z1.d,z2.d”. Furthermore, in a case where the operation with lane shift is the logical product, it is sufficient to define a logical product instruction with SIMD lane shift, for example, as “and′ z0.d,z1.d,z2.d”. Furthermore, in a case where the operation with lane shift is the exclusive logical OR, it is sufficient to define an exclusive logical OR instruction with SIMD lane shift, for example, as “eor′ z0.d,z1.d,z2.d”.

Furthermore, in the embodiment, the lane-shift operation instruction execution unit 211 performs an operation using the value of each lane of the first SIMD register 140 and the value of the lane on the LSB side of the second SIMD register and stores the operation result in each lane of the third SIMD register 140. Then, it has been described that the lane-shift operation instruction execution unit 211 shifts the value of each lane of the second SIMD register 140 to the right by one lane after the operation and stores the value in the second SIMD register 140. However, the lane-shift operation instruction execution unit 211 may perform left shift instead of the right shift. For example, the lane-shift operation instruction execution unit 211 may shift the value of each lane of the second SIMD register 140 to the left by one lane after the operation and store the value in the second SIMD register 140.

Furthermore, in the embodiment, it has been described that the lane-shift operation instruction execution unit 211 performs an operation using the value of each lane of the first SIMD register 140 and the value of the lane on the LSB side of the second SIMD register and stores the operation result in each lane of the third SIMD register 140. However, the lane-shift operation instruction execution unit 211 may use a specific lane other than the lane on the LSB side, instead of the lane on the LSB side of the second SIMD register.

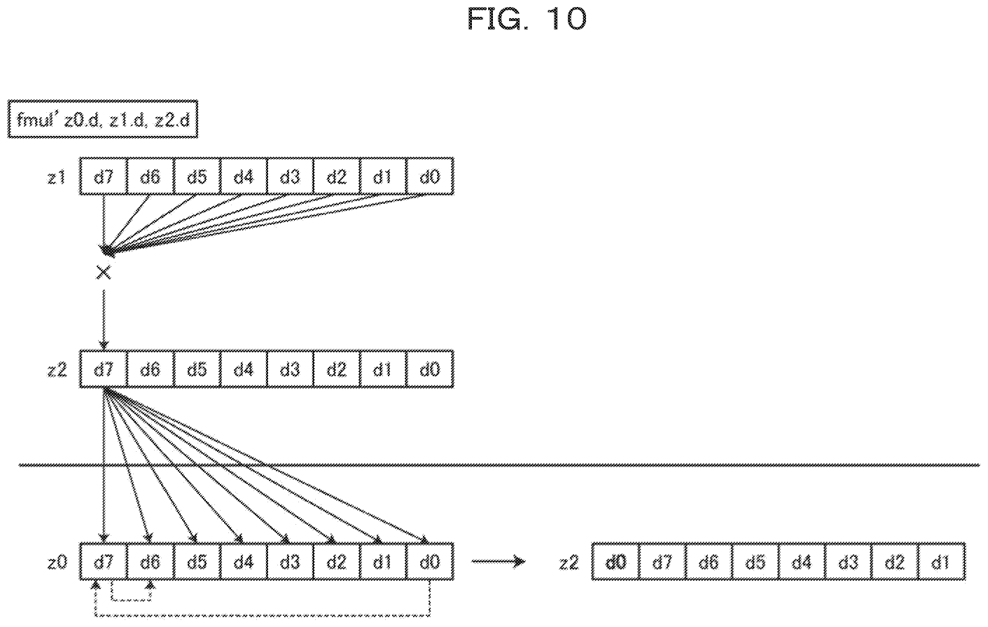

Here, a modification will be described in which the lane-shift operation instruction execution unit 211 uses the specific lane other than the lane on the LSB side, instead of the lane on the LSB side of the second SIMD register. Here, description is made by applying multiplication as an example of the operation. FIG. 10 is a diagram illustrating a modification of the multiplication instruction with SIMD lane shift according to the embodiment. In FIG. 10, a case will be described where the lane-shift operation instruction execution unit 211 uses a lane on an MSB side. The multiplication instruction with SIMD lane shift illustrated in FIG. 10 is defined as “fmul′ z0.d,z1.d,z2.d”. The SIMD register z1 stores a multiplicand in each lane. The SIMD register z2 stores a multiplier in each lane. The SIMD register z0 is a destination register.

A multiplication instruction fmul′ with SIMD lane shift multiplies [value of each lane of SIMD register z1]×[d7 (lane #7) of SIMD register z2] and stores the multiplication result in each lane of the SIMD register z0. In addition, fmul′ shifts data of the SIMD register z2 to the right by only one lane, after the multiplication. For example, a value of a #(i+1)-th lane is stored in a #i-th (i=0 to 6) lane of the SIMD register z2. A value of a zero-th (LSB side) lane is stored in a seventh (MSB side) lane. Note that the value of each lane of the SIMD register z1 is not changed.

As a result, regarding the coefficients c0, c1, c2, and c3 of the polynomial calculation illustrated in FIG. 1, if (c3, c2, c1, c0, c3, c2, c1, c0) is stored in the SIMD register z2 in advance, the source program 100 including the polynomial calculation can realize an efficient execution code.

Furthermore, in the embodiment, the lane-shift operation instruction execution unit 211 performs an operation using the value of each lane of the first SIMD register 140 and a value of a predetermined specific lane on the second SIMD register and stores the operation result in each lane of the third SIMD register 140. Then, it has been described that the lane-shift operation instruction execution unit 211 shifts the value of each lane of the second SIMD register 140 by one lane after the operation and stores the value in the second SIMD register 140. However, the lane-shift operation instruction execution unit 211 may use a designated lane, instead of the specific lane of the second SIMD register. However, the lane that can be designated is limited to “0” or “1”. This is because, although an instruction of a 64-bit mode CPU of the Arm architecture includes 32 bits, only one bit used to designate a lane can be secured in the 32-bit configuration (refer to FIG. 14). Therefore, the lane that can be designated is limited to “0” or “1”. In a case where the operation with designated lane shift is multiplication, it is sufficient to define a multiplication instruction with designated lane shift of a SIMD lane, for example, as “fmul′ z0.d,z1.d,z2.d[n]” (n=0 or 1).

### Effects of Embodiment

According to the embodiment described above, the information processing device 1 performs an operation between each lane of the first SIMD register having the lane for storing the first input data and the specific lane of the second SIMD register having the lane for storing the second input data, and the information processing device 1 executes processing of the SIMD instruction for storing the operation result in the third SIMD register, shifting the data of each lane of the second SIMD register by one lane, and storing the data in the second SIMD register. According to the configuration, the information processing device 1 can realize the efficient execution code by using the SIMD instruction.

Furthermore, according to the embodiment described above, the specific lane of the second SIMD register is specified by the SIMD instruction. As a result, even in a case of a SIMD register in the Arm architecture equal to or more than 256 bits, it is possible to perform the operation using each element of the first SIMD register and the data of the specific lane of the second SIMD register.

Furthermore, according to the embodiment described above, a circuit for shifting a fixed length for one lane is used for the shift of the second SIMD register. As a result, the information processing device 1 can implement an arithmetic circuit of which a processing time of shift processing is reduced, as compared with a circuit that shifts an arbitrary length.

Furthermore, according to the embodiment described above, the operation includes an addition operation, a subtraction operation, a multiplication operation, a division operation, a remainder operation, a product-sum operation, and a logical operation. As a result, the information processing device 1 can further realize an efficient execution code by using the operation instruction with lane shift for various operations.

Furthermore, according to the embodiment described above, the information processing device 1 performs an operation between each lane of the first SIMD register that stores each of pieces of data as many as the number of the sequences according to the bit length of the first SIMD register in the lane and the specific lane of the second SIMD register that stores each of the plurality of coefficients used for the polynomial calculation in the lane, in the polynomial calculation with respect to the sequence, in the operation processing. Then, the information processing device 1 shifts the data of each lane of the second SIMD register by one lane and stores the data in the second SIMD register, in the storing processing. As a result, the information processing device 1 can realize a calculation of a plurality of terms in order by storing the plurality of coefficients used for the polynomial calculation in the single SIMD register (second SIMD register), and it is possible to reduce the number of required SIMD registers. As a result, the information processing device 1 can realize the efficient execution code for the polynomial calculation with respect to the sequence.

### [Others]

Note that each illustrated component of the information processing device 1 does not necessarily have to be physically configured as illustrated in the drawings. For example, specific aspects of separation and integration of the information processing device 1 are not limited to the illustrated ones, and all or a part thereof may be functionally or physically separated or integrated in any unit depending on various loads, use situations, or the like. Furthermore, the storage unit 30 may be coupled through a network as an external device of the information processing device 1.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A processor for executing processing of a single instruction multiple data (SIMD) instruction, the processing comprising:
performing an operation between each lane of a first SIMD register that has a lane that stores first input data and a specific lane of a second SIMD register that has a lane that stores second input data;
storing the operation result in a third SIMD register; and
shifting data of each lane of the second SIMD register by one lane and storing the data in the second SIMD register.

2. The processor according to claim 1, wherein
the specific lane of the second SIMD register is specified by the SIMD instruction.

3. The processor according to claim 1, wherein
a circuit that shifts a fixed bit length for one lane is used for shift of the second SIMD register.

4. The processor according to claim 1, wherein
the operation includes an addition operation, a subtraction operation, a multiplication operation, a division operation, a remainder operation, a product-sum operation, and a logical operation.

5. The processor according to claim 1, wherein
in a polynomial calculation with respect to a sequence, the processing of performing the operation includes performing an operation between each lane of the first SIMD register that stores each of pieces of data as many as the number of sequences according to a bit length of the first SIMD register in the lane and the specific lane of the second SIMD register that stores a plurality of coefficients used for the polynomial calculation in each lane, and
the storing processing includes shifting the data of each lane of the second SIMD register by one lane and storing the data in the second SIMD register.

6. A non-transitory computer-readable recording medium storing a program causing a computer to execute a processing of:
executing processing of a single instruction multiple data (SIMD) instruction:
performing an operation between each lane of a first SIMD register that has a lane that stores first input data and a specific lane of a second SIMD register that has a lane that stores second input data;
storing the operation result in a third SIMD register; and
shifting data of each lane of the second SIMD register by one lane and storing the data in the second SIMD register.

7. An information processing device comprising:
a first SIMD register including a lane that stores first input data;
a second SIMD register including a lane that stores second input data;
a third SIMD register; and
a processor configured to:
execute processing of a single instruction multiple data (SIMD) instruction, the processing including
perform an operation between each lane of the first SIMD register and a specific lane of the second SIMD register,
storing the operation result in the third SIMD register, and
shift data of each lane of the second SIMD register by one lane and storing the data in the second SIMD register.
